(19) United States
(12) Patent Application Publication
(10) Pub. No.: US 2012/0155948 A1
(43) Pub. Date: Jun. 21, 2012

(54) RING BINDER MECHANISM

(76) Inventor: Chun Yuen TO, Hong Kong (CN)

(21) Appl. No.: 13/403,361

(22) Filed: Feb. 23, 2012

Related U.S. Application Data
(63) Continuation-in-part of application No. 12/868,847, filed on Aug. 26, 2010.

(30) Foreign Application Priority Data
Jun. 2, 2010 (CN) 201010192164

(51) Int. Cl. B42F 13/20

(52) U.S. Cl. 402/31

(57) ABSTRACT

A ring binder mechanism to be secured with a cover is disclosed as including an upper housing with two through holes and two side skirts depending from the housing, a pair of hingedly engaged plates supported by the housing, and a number of pairs of half-rings mounted to the plates, and the plates are pivotable between an open configuration in which the half-rings are open and a closed configuration in which the half-rings are closed to form a number of closed rings, and each through hole is to be secured with the cover via a rivet only, and that at least part of the side skirts abut the cover when the ring binder mechanism is secured with the cover.

This is a Continuation-In-Part of U.S. patent application Ser. No. 12/868,847 filed on 26 Aug. 2010.

This invention relates to a ring binder mechanism and, in particular, such a mechanism securable to a substrate to form a paper-retaining device, such as a box file or document holder, and a paper-retaining device incorporating such a ring binder mechanism.

In a conventional paper-retaining device such as box file or document holder, a ring binder mechanism may be fixedly secured to a substrate (e.g. a box file cover or document holder cover) for releasably retaining sheets of hole-punched paper or similar material. As the cover is usually made of such materials as cardboard or plastic and the ring binder mechanism is usually made of a metal or metal alloy, the ring binder mechanism is usually more durable than the cover. However, as the ring binder mechanism is fixedly secured to the cover, it is very difficult, if at all possible, to detach the mechanism from the substrate without damaging the cover and/or the ring binder mechanism.

In addition, when securing a ring binder mechanism to the cover, it is usually necessary to secure each hole of an upper housing of the ring binder mechanism with both an eyelet and a barrel, both made of a metal or a metal alloy, in order to engage the ring binder mechanism to the cover securely and stably. This clearly increases the use of materials and the cost of production.

It is thus an object of the present invention to provide a ring binder mechanism and a paper-retaining device incorporating such a ring binder mechanism in which the aforesaid shortcomings are mitigated, or at least to provide a useful alternative to the trade and public.

According to a first aspect of the present invention, there is provided a ring binder mechanism adapted to be secured with a substrate, said ring binder mechanism including a housing with at least one through hole and two side skirts depending from said housing, a pivotable structure supported by said housing, and a plurality of pairs of half-ring members mounted to said pivotable structure, wherein said pivotable structure is pivotable between an open configuration in which said pairs of half-ring members are open and a closed configuration in which said pairs of half-ring members are closed to form a plurality of closed rings, characterized in that said through hole is adapted to be secured with said substrate via one securing member only, and that said side skirts are adapted to abut said substrate along at least part of the length of said side skirts when said ring binder mechanism is secured with said substrate.

According to a second aspect of the present invention, there is provided a paper-retaining device including a ring binder mechanism secured with a substrate, wherein said ring binder mechanism includes a housing with at least one through hole and two side skirts depending from said housing, a pivotable structure supported by said housing, and a plurality of pairs of half-ring members mounted to said pivotable structure, wherein said pivotable structure is pivotable between an open configuration in which said pairs of half-ring members are open and a closed configuration in which said pairs of half-ring members are closed to form a plurality of closed rings, characterized in that said through hole is secured with said substrate via one securing member only, and that said side skirts abut said substrate along at least part of the length of said side skirts.

Embodiments of the present invention will now be described, by way of examples only, with reference to the accompany drawings, in which:

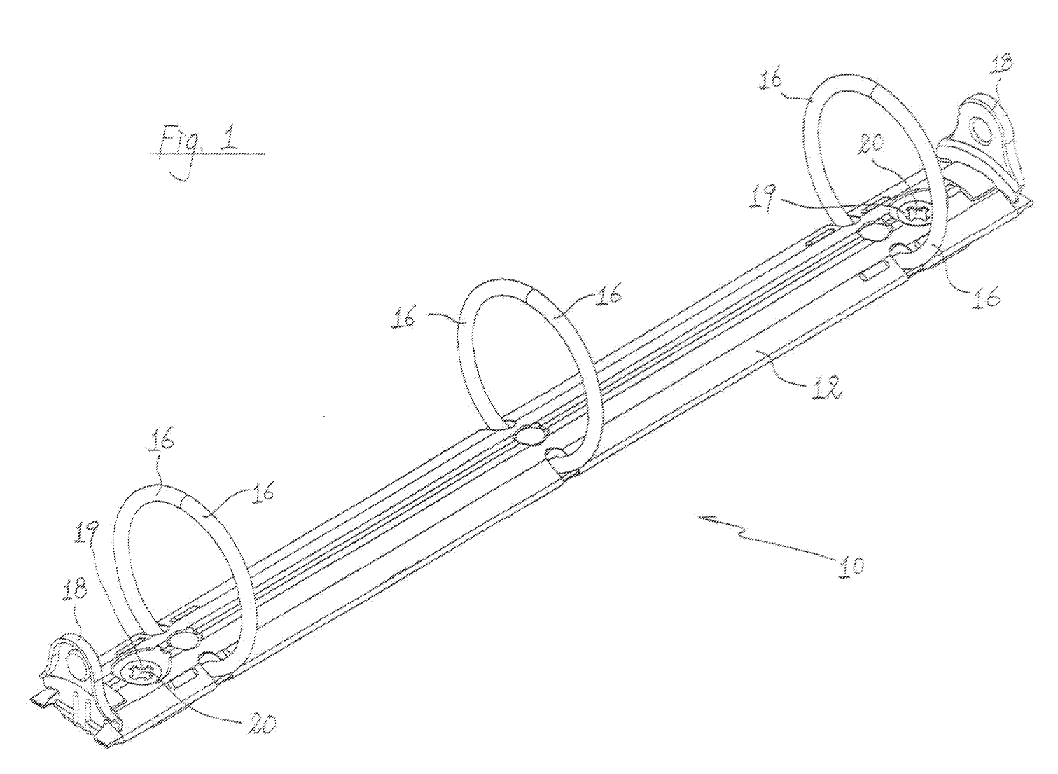

FIG. 1 is a top perspective view of a ring binder mechanism according to a first embodiment of the present invention;

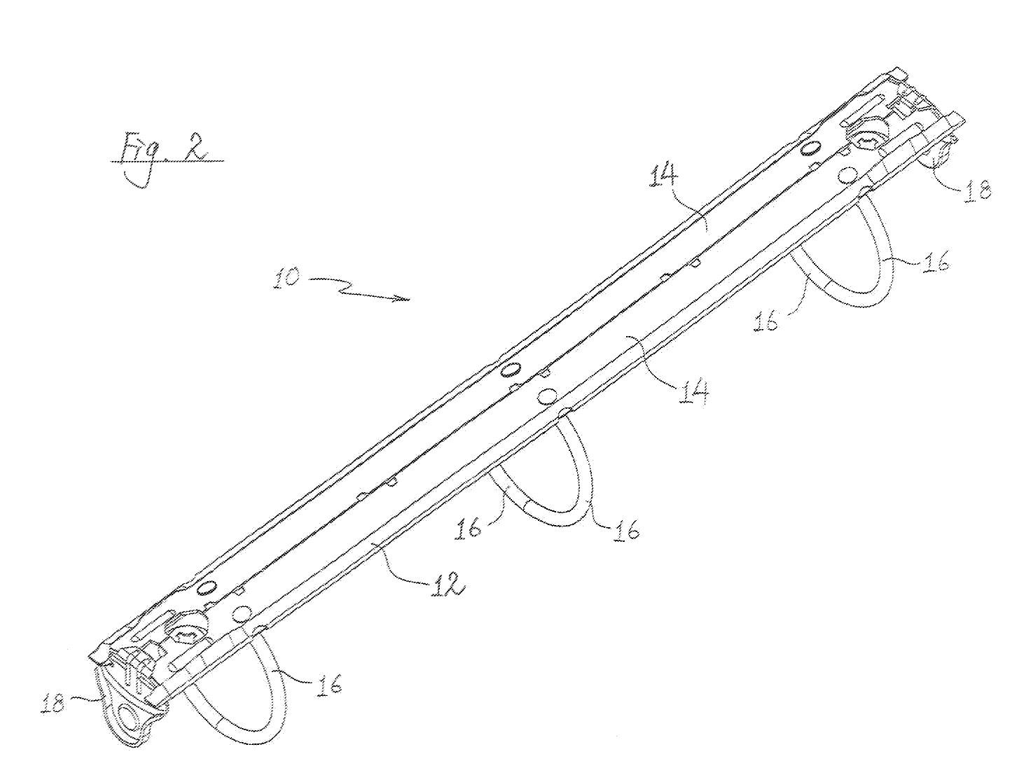

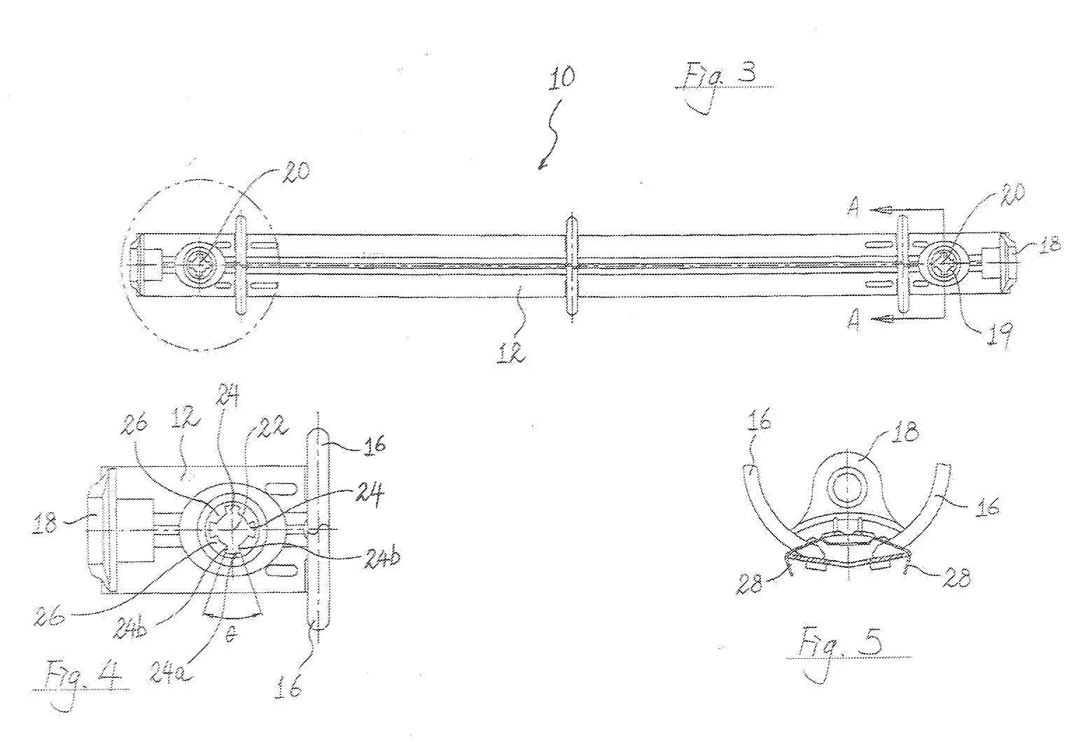

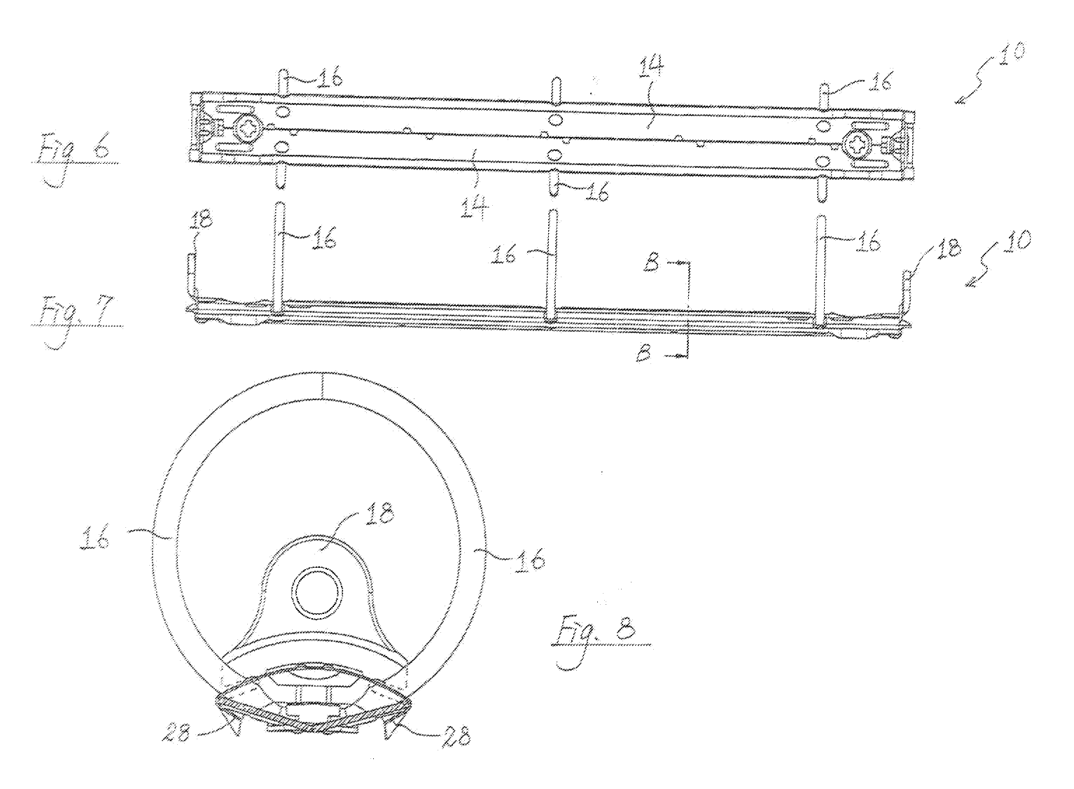

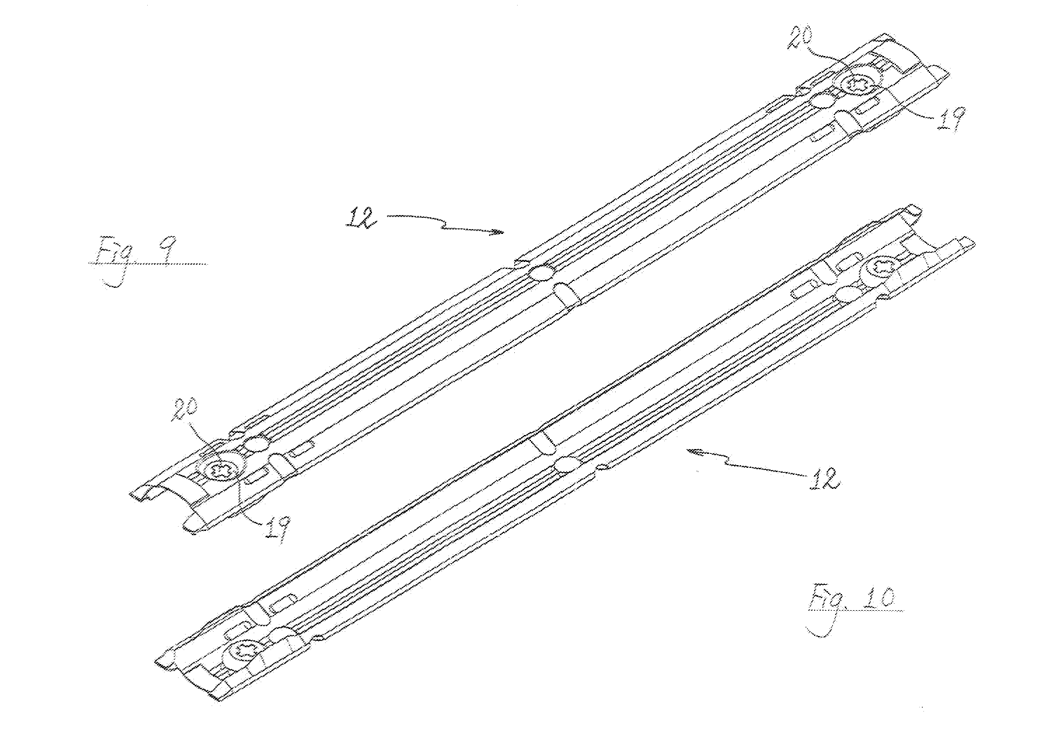

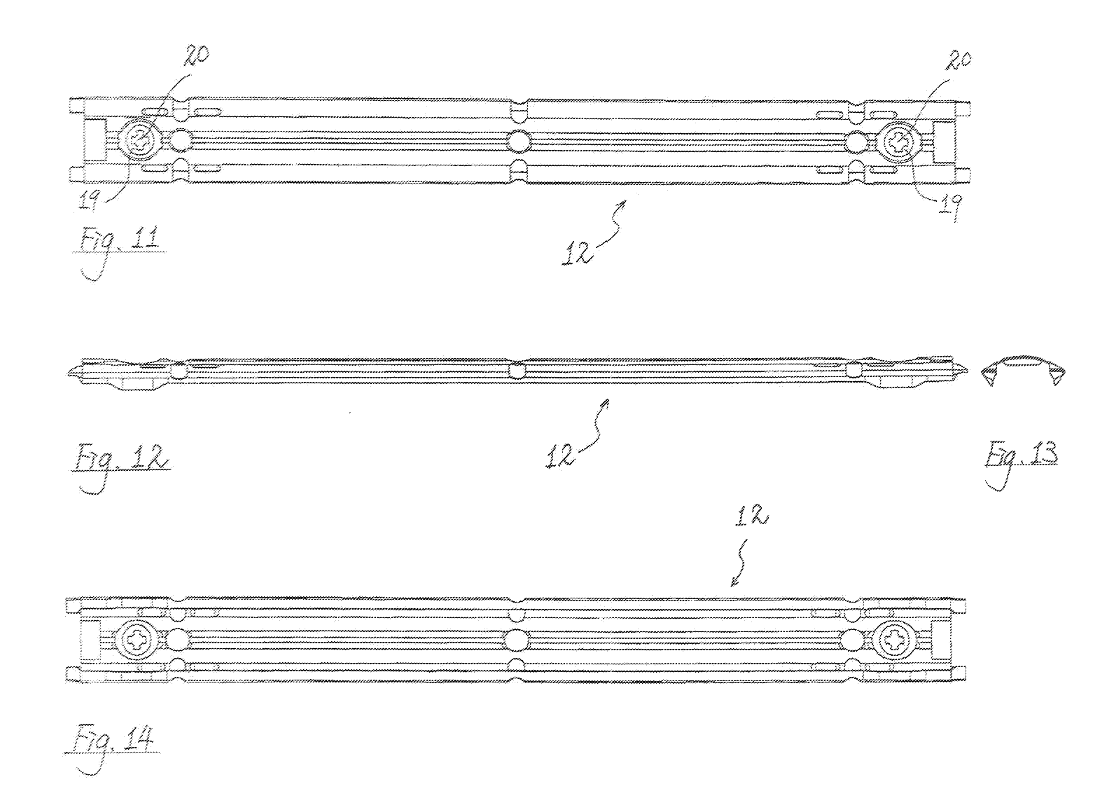

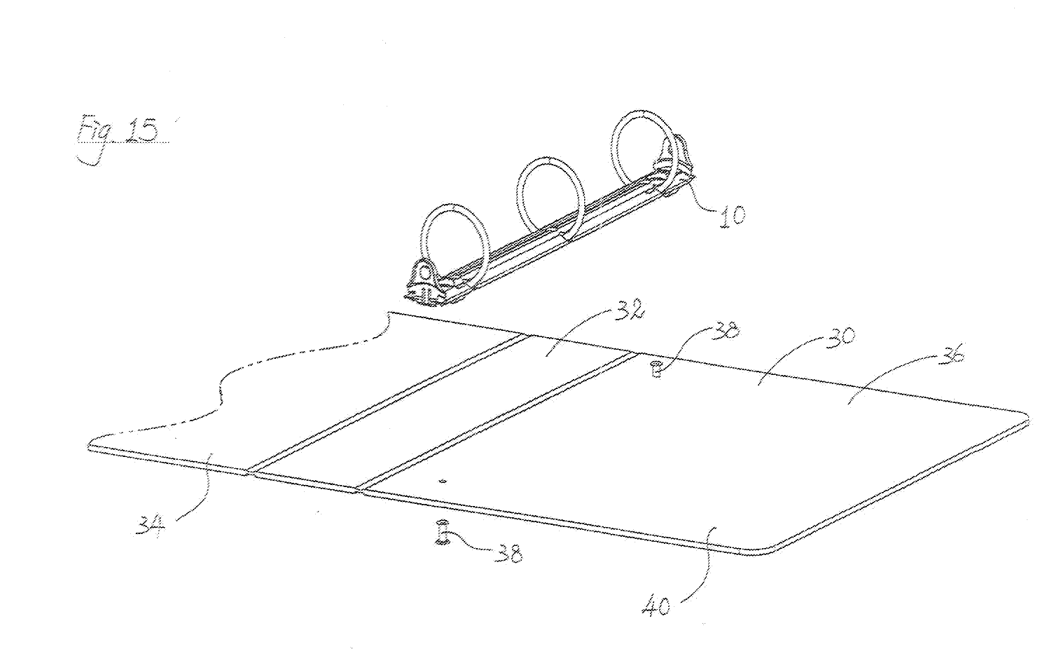

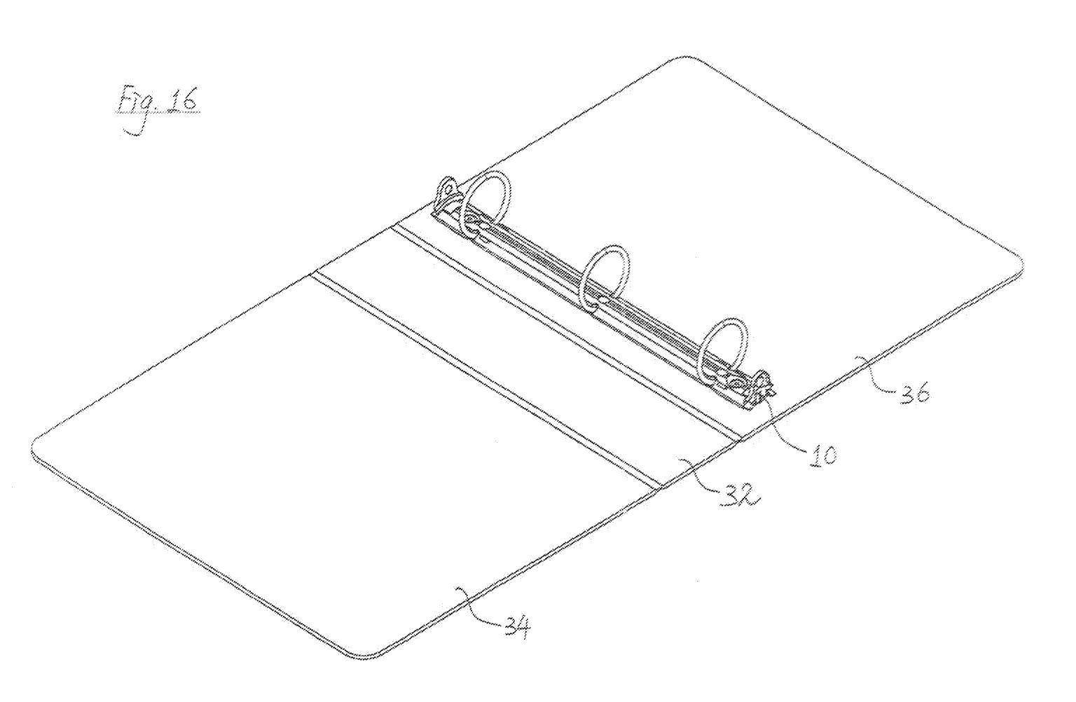

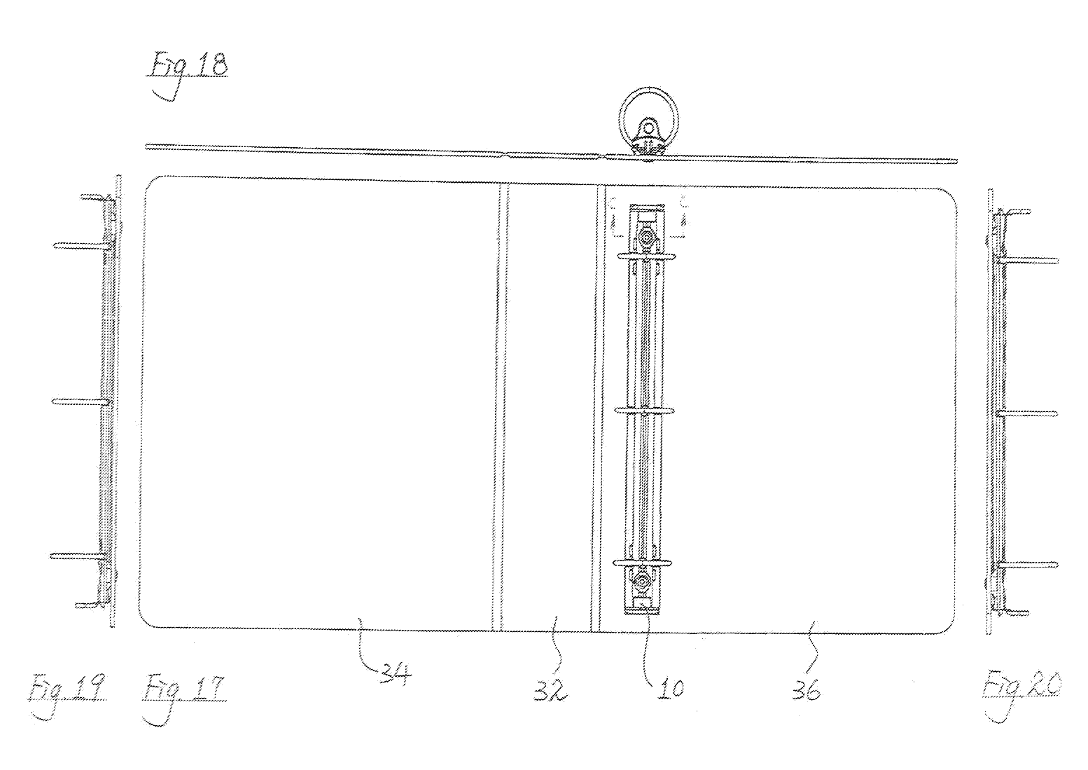

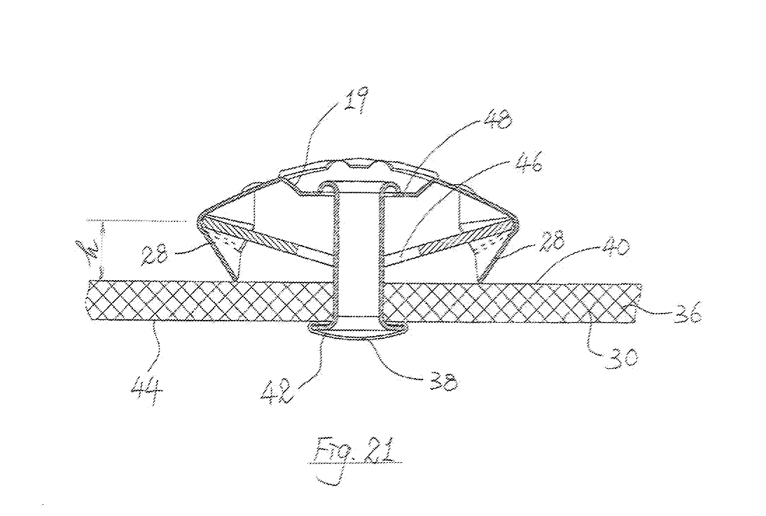

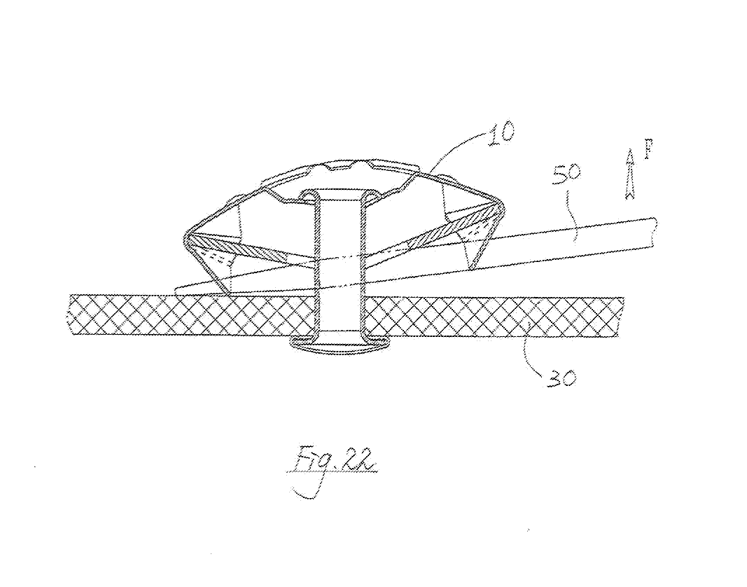

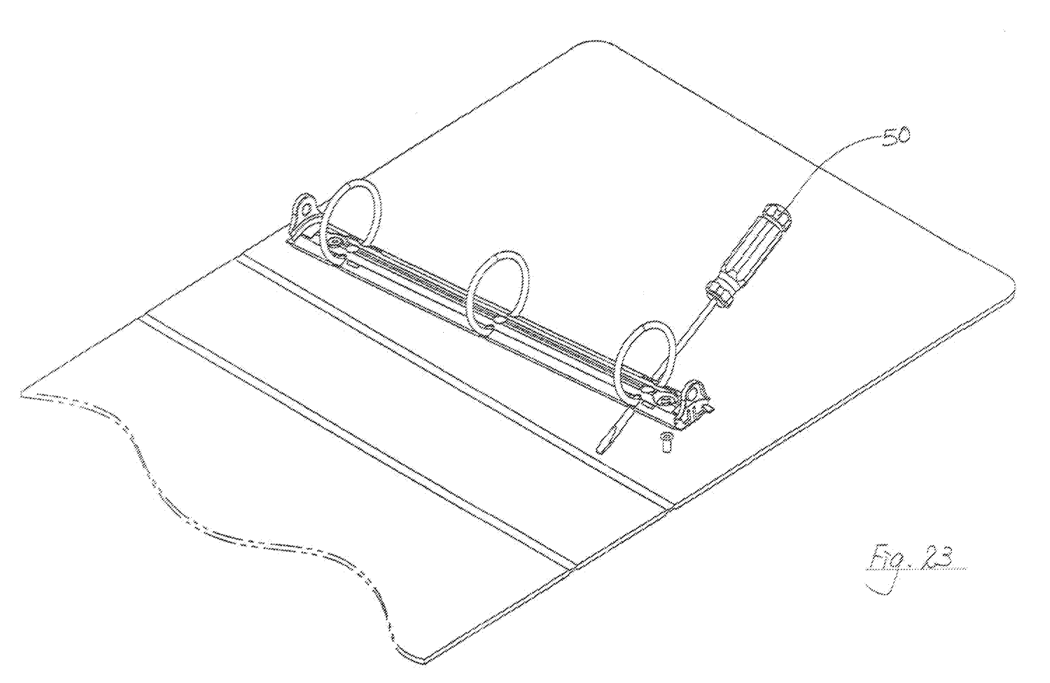

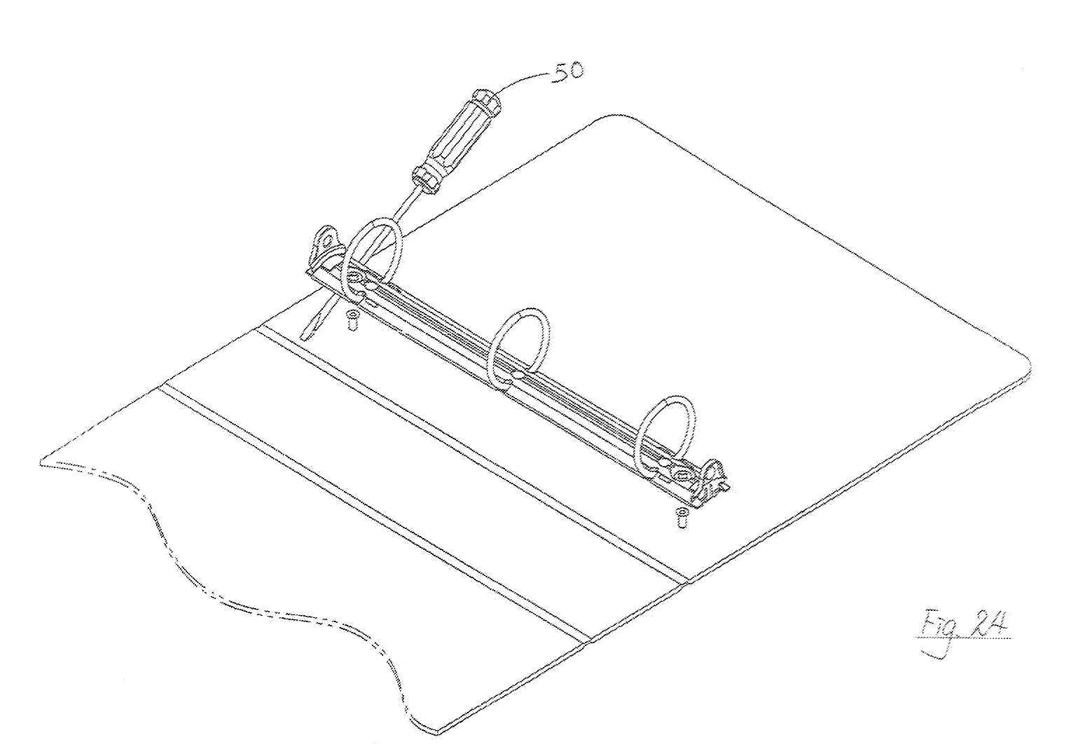

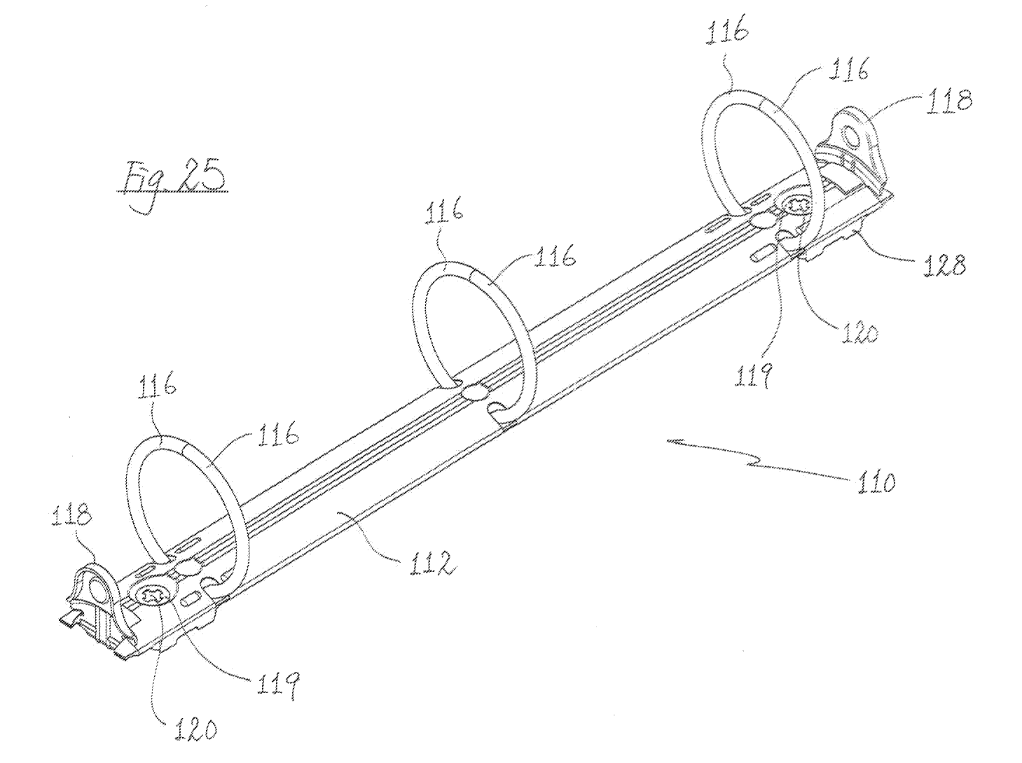

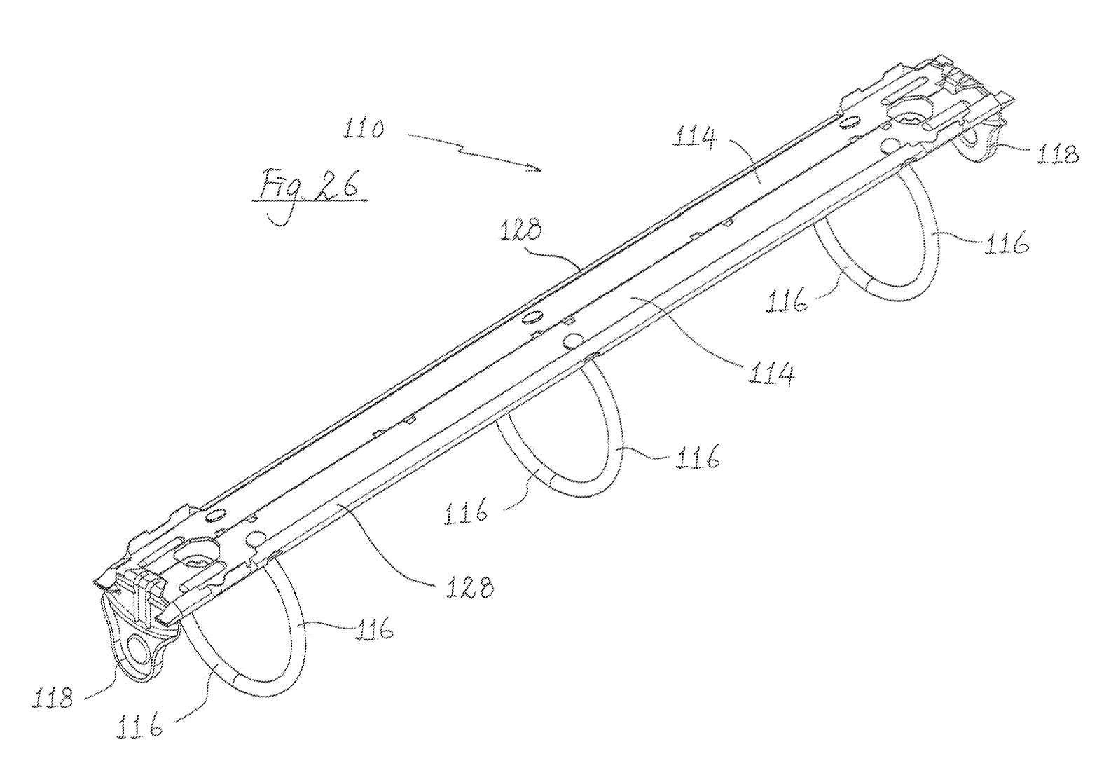

FIG. 2 is a bottom perspective view of the ring binder mechanism of FIG. 1;

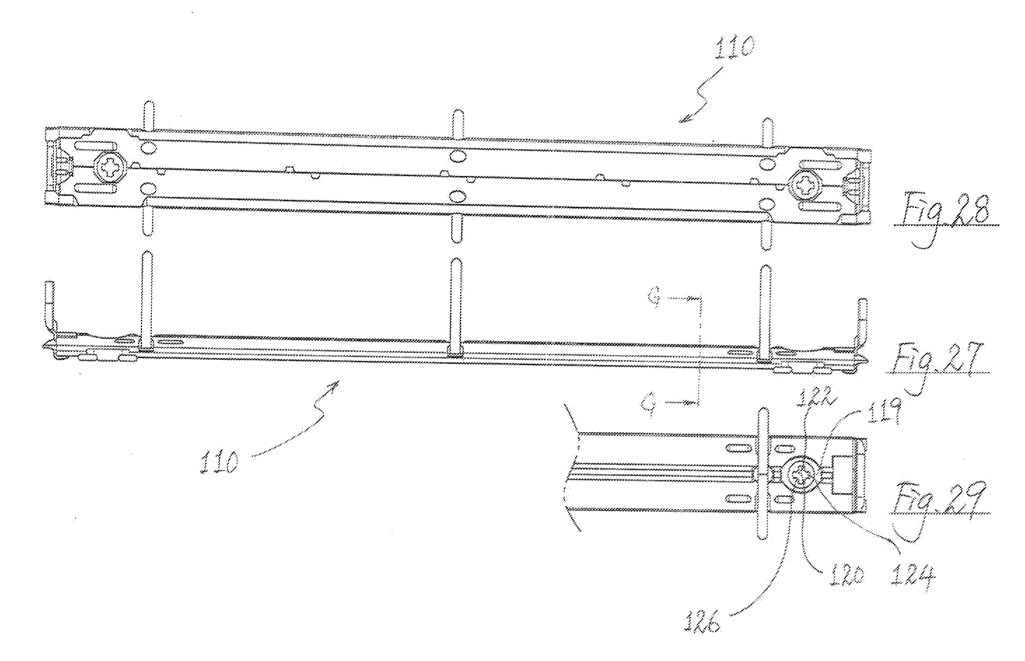

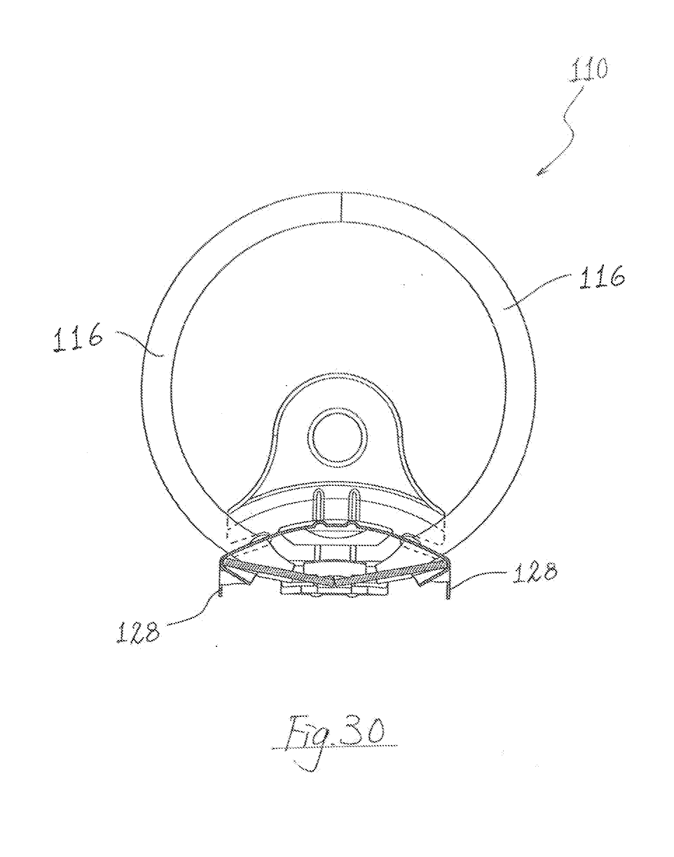

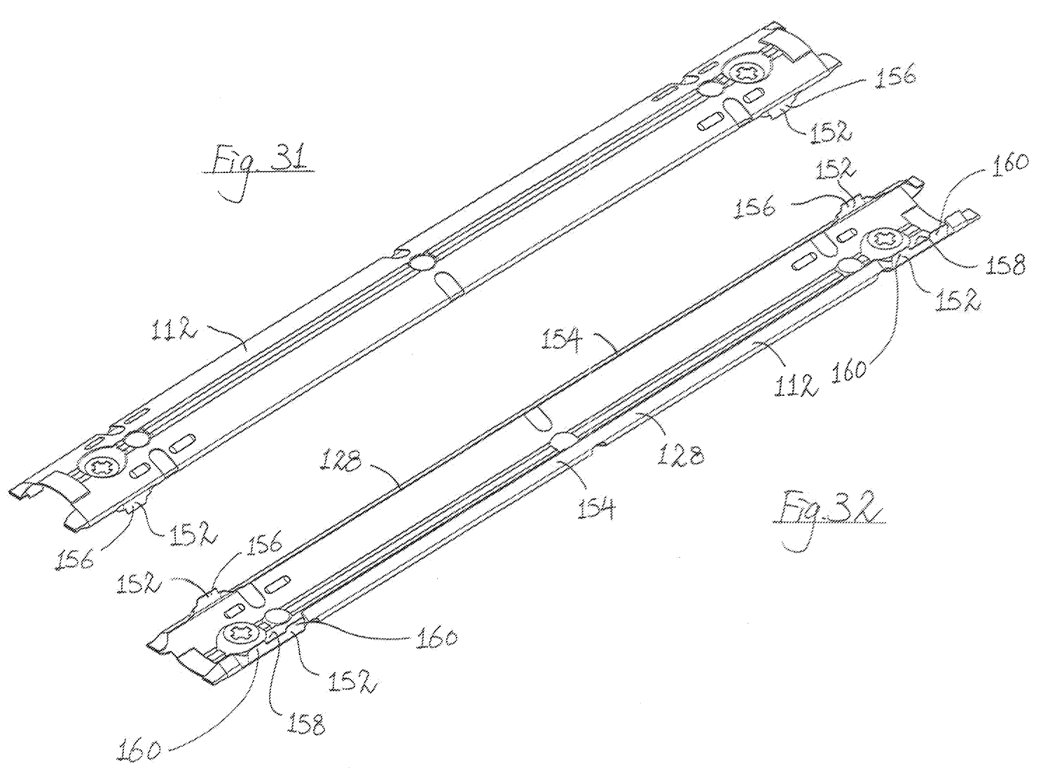

FIG. 3 is a top view of the ring binder mechanism of FIG. 1;

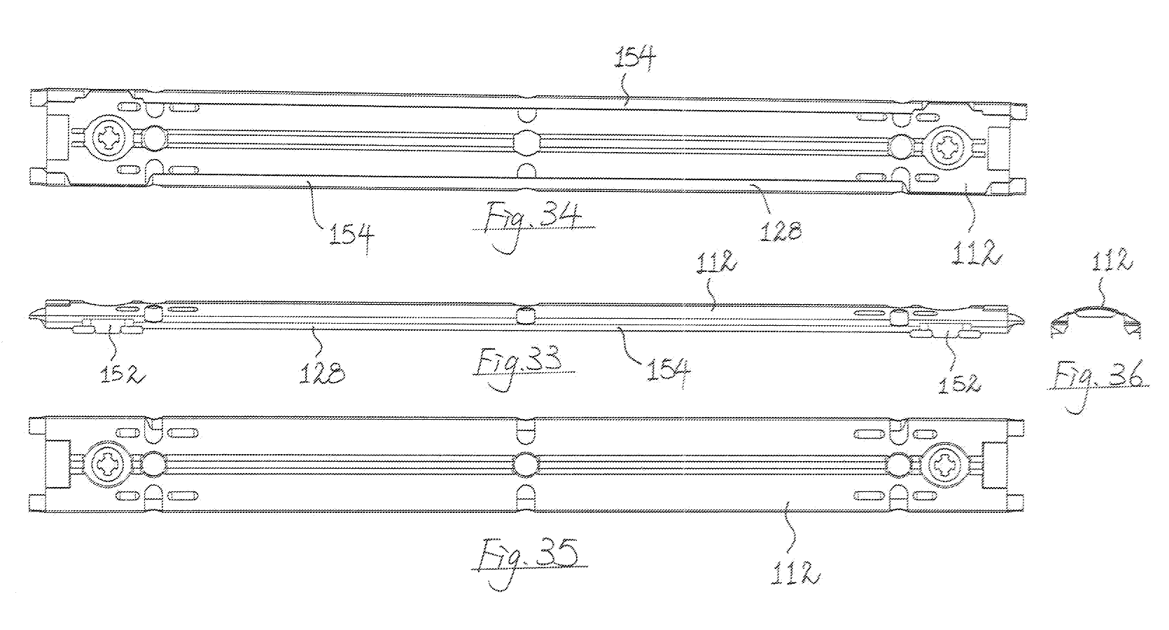

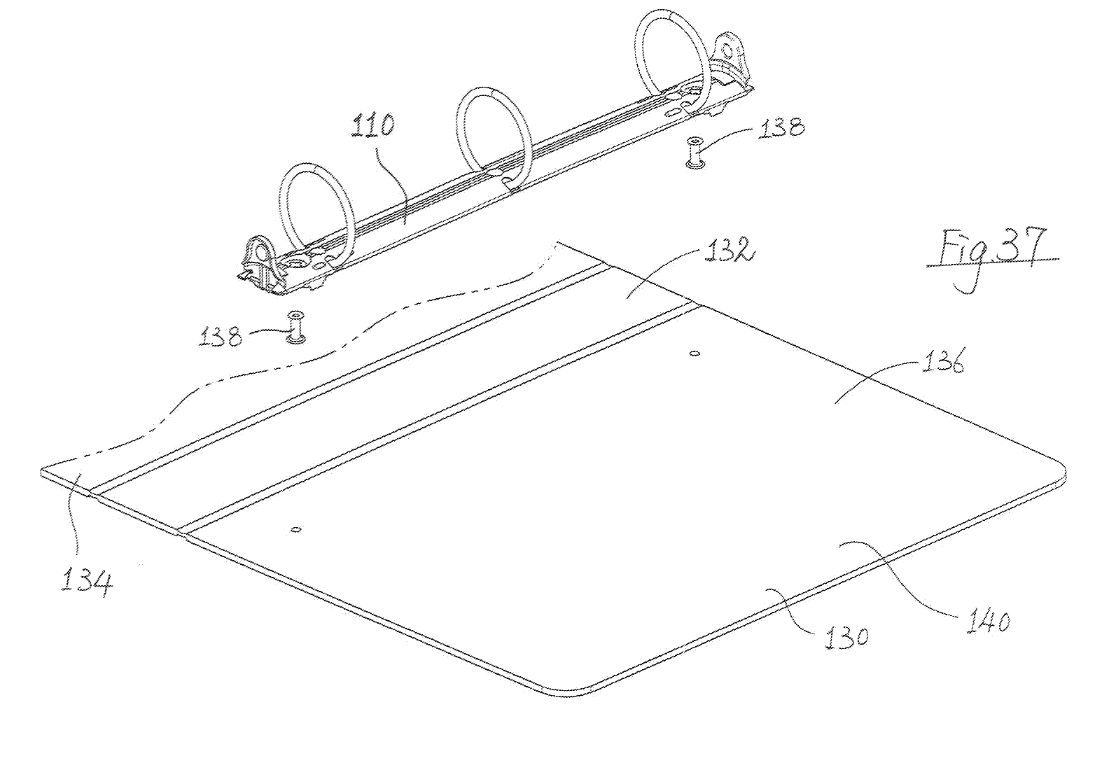

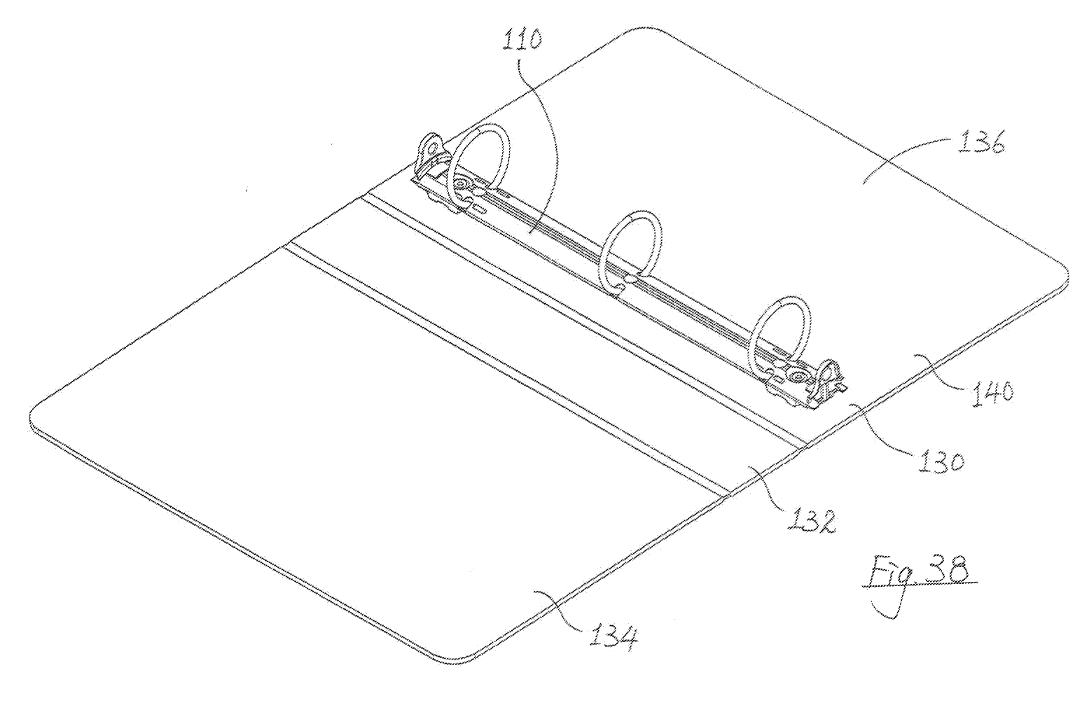

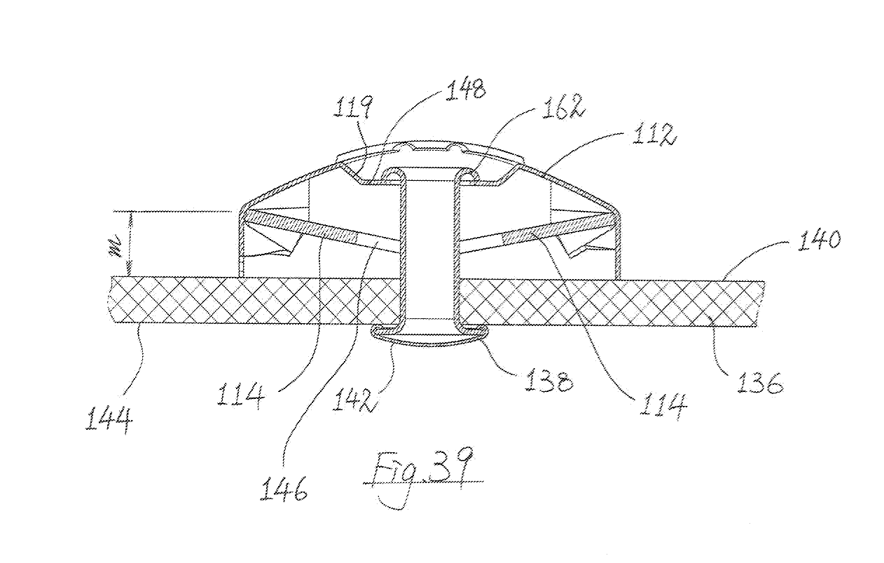

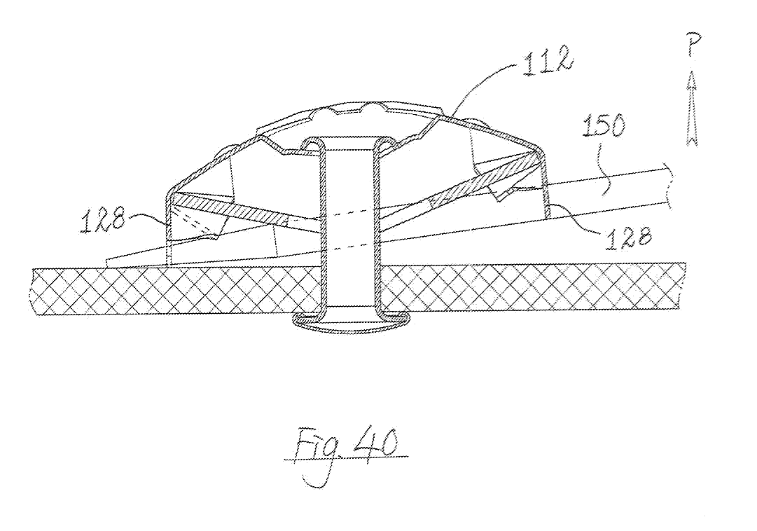

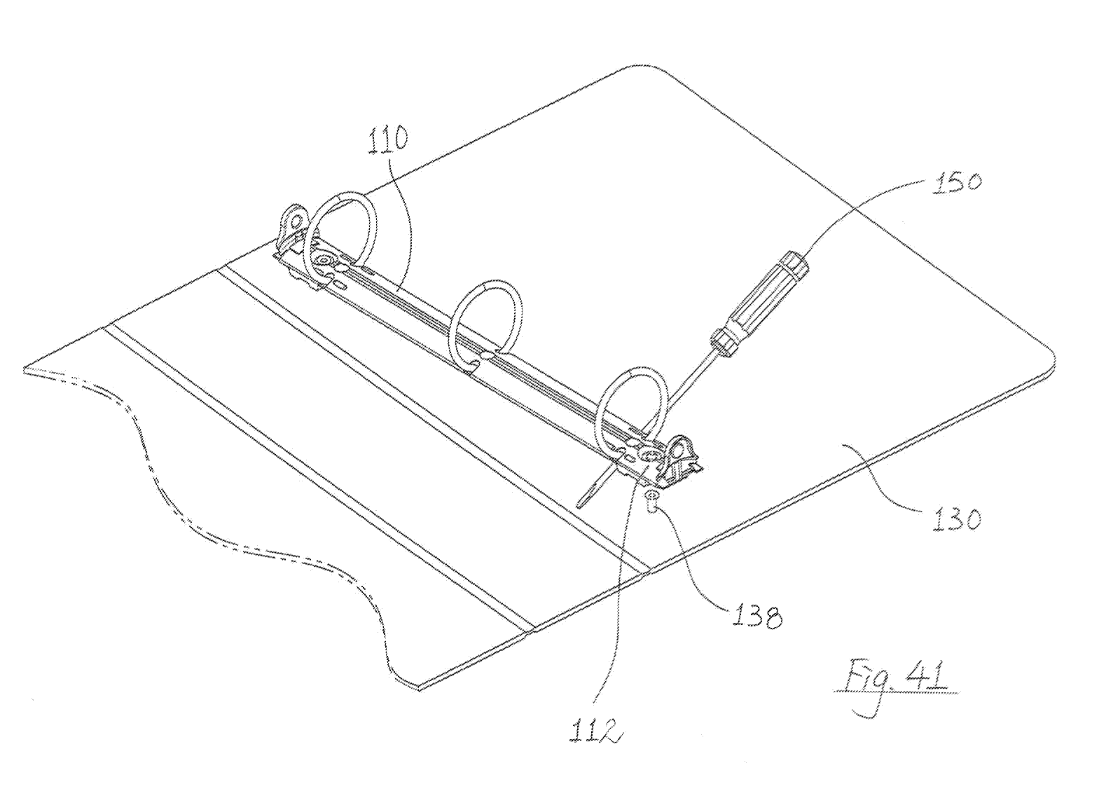

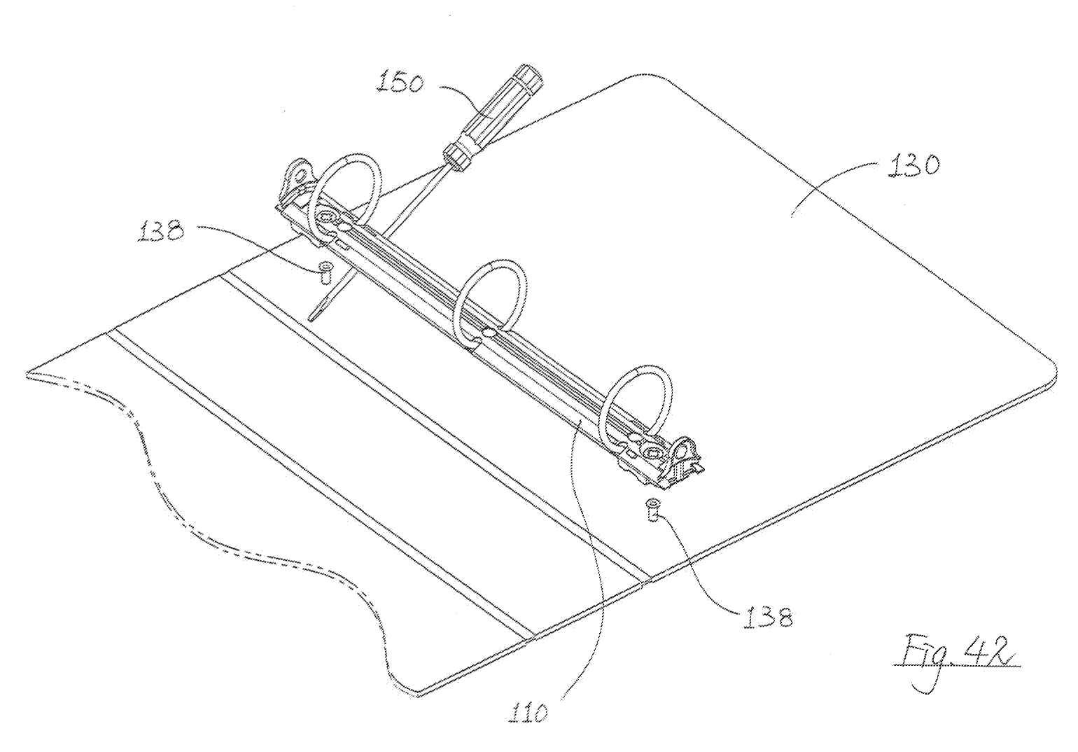

FIG. 4 is an enlarged view of the encircled part in FIG. 3;

FIG. 5 is a partial sectional view taken along the line A-A of FIG. 3;

FIG. 6 is a bottom view of the ring binder mechanism of FIG. 3;

FIG. 7 is a side view of the ring binder mechanism of FIG. 6;

FIG. 8 is a sectional view taken along the line B-B of FIG. 7;

FIG. 9 is a top perspective view of an upper housing of the ring binder mechanism of FIG. 1;

FIG. 10 is a bottom perspective view of the upper housing of FIG. 9;

FIG. 11 is a top view of the upper housing of FIG. 9;

FIG. 12 is a side view of the upper housing of FIG. 11;

FIG. 13 is an end view of the upper housing of FIG. 12;

FIG. 14 is a bottom view of the upper housing of FIG. 11;

FIG. 15 shows the ring binder mechanism of FIG. 1 to be secured with a cover;

FIG. 16 shows a paper-retaining device, comprising the ring binder mechanism of FIG. 1 secured with a cover;

FIG. 17 is a top view of the paper-retaining device of FIG. 16;

FIG. 18 is a front view of the paper-retaining device of FIG. 17;

FIG. 19 is a right side view of the paper-retaining device of FIG. 17;

FIG. 20 is a left side view of the paper-retaining device of FIG. 17;

FIG. 21 is an enlarged sectional view taken along the line C-C in FIG. 17 with the operating lever removed;

FIG. 22 shows insertion of a screwdriver between the ring binder mechanism and the cover of the paper-retaining device of FIG. 16;

FIGS. 23 and 24 show the steps of detaching the ring binder mechanism from the cover of the paper-retaining device of FIG. 16;

FIG. 25 is a top perspective view of a ring binder mechanism according to a second embodiment of the present invention;

FIG. 26 is a bottom perspective view of the ring binder mechanism of FIG. 25;

FIG. 27 is a side view of the ring binder mechanism of FIG. 25;

FIG. 28 is a bottom view of the ring binder mechanism of FIG. 27;

FIG. 29 is a partial top view of the ring binder mechanism of FIG. 27;

FIG. 30 is an enlarged sectional view of the ring binder mechanism taken along the line G-G of FIG. 27;

FIG. 31 is a top perspective view of an upper housing of the ring binder mechanism of FIG. 25;

FIG. 32 is a bottom perspective view of the upper housing of FIG. 31;

FIG. 33 is a side view of the upper housing of FIG. 31;

FIG. 34 is a bottom view of the upper housing of FIG. 33;

FIG. 35 is a top view of the upper housing of FIG. 33;

FIG. 36 is an end view of the upper housing of FIG. 33;

FIG. 37 shows the ring binder mechanism of FIG. 25 to be secured with a cover;

FIG. 38 shows a paper-retaining device, comprising the ring binder mechanism of FIG. 25 secured with a cover;

FIG. 39 is an enlarged transverse sectional view of the paper-retaining device of FIG. 38, with the operating lever removed;

FIG. 40 shows insertion of a screwdriver between the ring binder mechanism and the cover of the paper-retaining device of FIG. 38;

FIGS. 41 and 42 show the steps of detaching the ring binder mechanism from the cover of the paper-retaining device of FIG. 38;

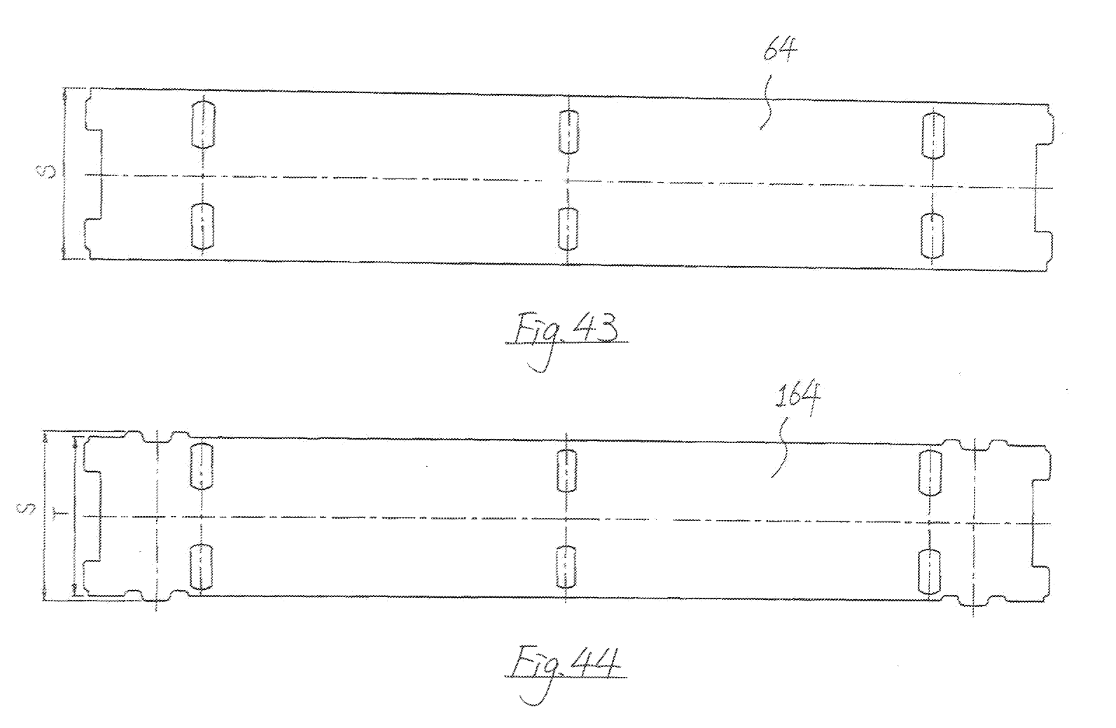

FIG. 43 shows a metal sheet suitable for manufacturing the upper housing of FIG. 9; and

FIG. 44 shows a metal sheet suitable for manufacturing the upper housing of FIG. 31.

FIGS. 1 to 8 show various views of a ring binder mechanism according to a first embodiment of the present invention, generally designated as 10. The ring binder mechanism 10 has an upper housing 12 supporting a pair of plates 14 which are hinged with each other for relative pivoting action.

To each of the plates 14 are mounted three half-rings 16. Each longitudinal end of the ring binder mechanism 10 is engaged with a respective operating lever 18. The operating levers 18 are pivotable relative to the housing 12 and the plates 14 to selectively pivot the pair of plates 14 between a closed configuration and an open configuration. When the pair of plates 14 are in the closed configuration, the surfaces of the pair of plates 14 facing the housing 12 subtend an angle of less than 180° such that free ends of the three pairs of half-rings 16 mate and contact with each other to form three closed rings (as shown in FIGS. 1 to 8). When the pair of plates 14 are in the open configuration, the surfaces of the pair of plates 14 facing the housing 12 subtend an angle of over 180° such that the free ends of the three pairs of half-rings 16 are out of contact with each other to open the rings.

It is of course well known to persons skilled in the art that it is possible to open or close the rings by forcing the free ends of the half-rings 16 apart or together, thus dispensing with the operating levers 18.

As shown in FIGS. 1 and 3, adjacent each longitudinal end of the housing 12 is provided a recessed region 19 with a through hole 20. As can be seen more clearly in FIG. 4, each through hole 20 has a central generally circular aperture 22 and four equi-angularly positioned recesses 24 adjoining the central aperture 22. Each recess 24 has an outer curved edge 24a adjoining two straight side edges 24b. The two side edges 24b subtend an angle of 50°. By way of such an arrangement, four equi-angularly positioned tongues 26 are formed around the central aperture 22 of each through hole 20. These tongues 26 are to be engaged with a rivet (also called “eyelet”) for engaging the ring binder mechanism 10 with a cover, to be discussed below.

It can also be seen from FIGS. 5 and 8 that the housing 12 has two lateral side skirts 28 depending therefrom.

FIGS. 9 to 14 show various views of the housing 12 of the ring binder mechanism 10.

As shown in FIG. 15, a paper-retaining device (e.g. a box file or document holder) may be formed by securing the ring binder mechanism 10 to a substrate, e.g. a cover 30. The cover 30 may be made of cardboard, plastics, metal, metal alloy or a combination of such materials. The cover 30 includes a central spine 32 which is hingedly joined on one side with a front cover 34 and on another side with a rear cover 36. The ring binder mechanism 10 is then secured to an inner major surface 40 of the rear cover 36 by two rivets 38. A paper-retaining device so formed is shown in FIGS. 16 to 20.

It can be seen from FIG. 21 that each through hole 20 is engaged with the cover 30 via a rivet 38 only. The rivet 38 is received through the cover 30 in such a way that a longitudinal head 42 of the rivet 38 is in contact with an outer major surface 44 of the rear cover 36 which is opposite to the inner major surface 40. The rivet 38 is also received through a hole 46 formed between the pair of hinged plates 14, which is aligned with the through hole 20. An upper longitudinal end of the rivet 38 is deformed to be engaged with an upper surface 48 of the housing 12 around the through hole 20. In particular, the deformed upper longitudinal end of the rivet 38 is engaged with the tongues 26 around the through hole 20.

To enhance the stability of the ring binder mechanism 10 relative to the cover 30, it can be seen from FIG. 21 that, when the ring binder mechanism 10 is secured with the cover 30, the side skirts 28 abut the inner surface 40 of the rear cover 36 of the cover 30 along the whole length of the side skirts 28. It should be noted that the effective height h of the side skirts 28 above the cover 30 is such that the pivoting movement of the operating levers 18 is not hindered by the cover 30.

When it is desired to disassemble the paper-retaining device by detaching the ring binder mechanism 10 from the cover 30, and as shown in FIG. 22, a screwdriver 50 may be inserted between the ring binder mechanism 10 and the cover 30 adjacent one longitudinal end of the ring binder mechanism 10. The screwdriver 50 may then be pivoted in the direction indicated by the arrow F, so as to disengage the deformed upper longitudinal end of the rivet 38 from one or two tongues 26 around the hole 20, whereby one longitudinal end of the ring binder mechanism 10 may be detached from the rivet 38, as shown in FIG. 23. More particularly, in doing so, the deformed upper longitudinal end of the rivet 38 is slid through the space between the outer curved edges 24a and adjoining straight side edges 24b of the two diametrically opposed recesses 24 which are positioned generally on the centre line of the housing 12. The other longitudinal end of the ring binder mechanism 10 may be detached from the cover 30 by the use of the screwdriver 50 in a similar manner.

An advantage of the present invention is that, as compared with the prior art ring binder mechanisms, the ring binder mechanism 10 of the present invention can be securely and stably engaged with a cover 30 although no barrel is used. Another advantage is that it is relatively easy to detach the ring binder mechanism 10 from the cover 30, if necessary and desired. Both of these features render the present ring binder mechanism 10 environmentally friendly, easier to manufacture and thus less costly.

FIGS. 25 to 30 show various views of a ring binder mechanism according to a second embodiment of the present invention, generally designated as 110. The ring binder mechanism 110 has an upper housing 112 supporting a pair of plates 114 which are hingedly engaged with each other for relative pivoting action.

To each of the plates 114 are mounted three half-rings 116. Each longitudinal end of the ring binder mechanism 110 is engaged with a respective operating lever 118. The operating levers 118 are pivotable relative to the housing 112 and the plates 114 to selectively pivot the pair of plates 114 between a closed configuration and an open configuration. When the pair of plates 114 are in the closed configuration, the surfaces of the pair of plates 114 facing the housing 112 subtend an angle of less than 180° such that free ends of the three pairs of half-rings 116 mate and contact with each other to form three closed rings (as shown in FIGS. 25 to 30). When the pair of plates 114 are in the open configuration, the surfaces of the pair of plates 114 facing the housing 112 subtend an angle of over 180° such that the free ends of the three pairs of half-rings 116 are out of contact with each other to open the rings.

It is of course possible to open or close the rings by forcing the free ends of the half-rings 116 apart or together, thus dispensing with the operating levers 118.

As shown in FIGS. 25 and 29, adjacent each longitudinal end of the housing 112 is provided a recessed region 119 with a through hole 120. As can be seen in FIG. 29, each through hole 120 (of which only one is shown in FIG. 29) has a central generally circular aperture 122 and four equi-angularly positioned recesses 124 adjoining the central aperture 122. Each recess 124 has an outer curved edge adjoining two straight side edges. The two side edges subtend an angle of 50°. By way of such an arrangement, four equi-angularly positioned tongues 126 are formed around the central aperture 122 of each through hole 120. These tongues 126 are to be engaged with a rivet (also called “eyelet”) for engaging the ring binder mechanism 110 with a substrate, to be discussed below.

It can be seen from FIGS. 25 to 28 and 30 that the housing 112 has two lateral side skirts 128. It can be seen more clearly in FIGS. 31 to 36 (which show various views of the housing 112 of the ring binder mechanism 110) that each of the two lateral side skirts 128 has two end portions 152 and an intermediate portion 154. The two end portions 152 are formed integrally with and adjoin the intermediate portion 154, each at a respective end of the intermediate portion 154.

The intermediate portions 154 are bent downwardly and inwardly, i.e. towards each other, such that, when the ring binder mechanism 110 is duly assembled, the intermediate portions 154 support the plates 114, and allow the plates 114 to exhibit pivoting movement relative to each other.

As to the two end portions 152 of each lateral side skirt 128, they are aligned with and parallel to each other. In addition, the two end portions 152 adjacent each respective longitudinal end of the housing 112 are also parallel to each other.

It can be seen more clearly in FIG. 32 that there are two types of end portions 152, each with a different shape. A first type of end portions 152 has a central protrusion 156; a second type of end portions 152 has a central recess 158 with two adjoining protrusions 160. The lower extremities (in the sense of FIGS. 30 and 31) of the central protrusion 156 of the first type of end portions 152 and the lower extremities of the protrusions 160 of the second type of end portions 152 are of the same height (again, in the sense of FIGS. 30 and 31). Thus, when the housing 112 is duly assembled and secured to a substrate (to be discussed below), the four end portions 152 (but not the intermediate portions 154) abut a major surface of the substrate to stably support the housing 112 to and on the substrate. Thus, when the ring binder mechanism 110 is secured with the substrate, the side skirts 128 abut the substrate along only part of the length of the side skirts 128.

In the exemplary housing 112 shown and discussed herein, two end portions 152 of the first type are provided along and on one side skirt 128, whereas two end portions 152 of the second type are provided along and on another side skirt 128. It should be understood that alternative arrangements may be made. For example, each of the two side skirts 128 may be provided with one end portion 152 of the first type and one end portion 152 of the second type.

As shown in FIGS. 37 and 38, a paper-retaining device (e.g. a box file or document holder) may be formed by securing the ring binder mechanism 110 to a substrate, e.g. a cover 130. The cover 130 may be made of cardboard, plastics, metal, metal alloy or a combination of such materials. The cover 130 includes a central spine 132 which is hingedly joined on one side with a front cover 134 and on another side with a rear cover 136. The ring binder mechanism 110 is then secured to an inner major surface 140 of the rear cover 136 by two rivets 138.

It can be seen from FIG. 39 that each through hole 120 is engaged with the rear cover 136 of the cover 130 via a rivet 138 only. The rivet 138 is received through the cover 130 in such a way that a longitudinal head 142 of the rivet 138 is in contact with an outer major surface 144 of the rear cover 136 which is opposite to the inner major surface 140. The rivet 138 is also received through a hole 146 formed between the pair of hingedly engaged plates 114, which is aligned with the through hole 120. An upper longitudinal end 162 of the rivet 138 is deformed to be engaged with an upper surface 148 of the housing 112 around the through hole 120. In particular, the deformed upper longitudinal end 162 of the rivet 38 is engaged with the tongues 126 around the through hole 120.

As discussed above, to enhance the stability of the ring binder mechanism 110 relative to the cover 130, it can be seen from FIG. 39 that, when the ring binder mechanism 110 is secured with the cover 130, the side skirts 128 abut the inner surface 140 of the rear cover 136 of the cover 130 along part of the length of the side skirts 128. In particular, the four end portions 152 of the side skirts 128 are perpendicular to and abut the inner surface 140 of the rear cover 136 of the cover 130. It should be noted that the effective height m of the side skirts 128 above the cover 130 is such that the pivoting movement of the operating levers 118 is not hindered by the cover 130.

When it is desired to disassemble the paper-retaining device by detaching the ring binder mechanism 110 from the cover 130, and as shown in FIG. 40, a screwdriver 150 may be inserted through the space between each intermediate portions 154 of the respective side skirt 128 of the ring binder mechanism 110 and the cover 130. As the intermediate portions 154 are bent towards each other, there are readily available two spaces (one provided by each side skirt 128) allowing insertion of the screwdriver 150 therethrough.

The screwdriver 150 may then be pivoted in the direction indicated by the arrow P in FIG. 40, so as to disengage the deformed upper longitudinal end 162 of the rivet 138 from one or two tongues 126 around the hole 120, whereby one longitudinal end of the ring binder mechanism 110 may be detached from the rivet 138, as shown in FIG. 41. More particularly, in doing so, the deformed upper longitudinal end 162 of the rivet 138 is slid through the space between the outer curved edges and adjoining straight side edges of the two diametrically opposed recesses 124 which are positioned generally on the centre line of the housing 112. The other longitudinal end of the ring binder mechanism 110 may be detached from the cover 130 by the use of the screwdriver 150 in a similar manner, as shown in FIG. 42.

An advantage of the present invention is that, as compared with the prior art ring binder mechanisms, the ring binder mechanism 110 of the present invention can be securely and stably engaged with the cover 130 although no barrel is used. Another advantage is that it is relatively easy to detach the ring binder mechanism 110 from the cover 130, if necessary and desired. Both of these features render the present ring binder mechanism 110 environmentally friendly, easier to manufacture and thus less costly.

Referring to FIG. 43, such shows a plan view of a metal sheet 64 suitable for manufacturing the upper housing 12 of FIG. 9. It can be seen that the metal sheet is of a width of S. Once the metal sheet 64 is cut out or punched out, e.g. from a larger metal sheet, such may then be bent or folded into the shape as shown in FIG. 9, to form the upper housing 12.

Turning to FIG. 44, such shows a plan view of a metal sheet 164 suitable for manufacturing the upper housing 112 of FIG. 31. Again, once the metal sheet 164 is cut out or punched out, e.g. from a larger metal sheet, such may then be bent or folded into the shape as shown in FIG. 31. It can be seen that less material is used (see the difference between the width S and the reduced width T as shown in FIG. 44) for making the upper housing 112 of the ring binder mechanism 110, thus further reducing the production cost.

A further advantage of the upper housing 112 of the ring binder mechanism 110 is that, less (or even no) damage is made to the upper housing 112 when such is removed from the cover 130 by the screwdriver 150, as two spaces between the cover 130 and the ring binder mechanism 110 are already provided, allowing insertion of the screwdriver 150 therethrough.

It should be understood that the above only illustrates and describes examples whereby the present invention may be carried out, and that modifications and/or alterations may be made thereto without departing from the spirit of the invention.

It should also be understood various features of the invention which are, for brevity, described here in the context of a single embodiment, may also be provided separately or in any suitable sub-combination. Similarly, it should also be understood that certain features of the invention, which are, for clarity, described in the context of separate embodiments, may be provided in combination in a single embodiment.

1. A ring binder mechanism adapted to be secured with a substrate, said ring binder mechanism including:
a housing with at least one through hole and two side skirts depending from said housing,
a pivotable structure supported by said housing, and
a plurality of pairs of half-ring members mounted to said pivotable structure, wherein said pivotable structure is pivotable between an open configuration in which said pairs of half-ring members are open and a closed configuration in which said pairs of half-ring members are closed to form a plurality of closed rings,
and wherein said through hole is adapted to be secured with said substrate via one securing member only, and that said side skirts are adapted to abut said substrate along at least part of the length of said side skirts when said ring binder mechanism is secured with said substrate.

2. A ring binder mechanism according to claim 1, wherein said housing includes at least two through holes with each of which a respective securing member is securable.

3. A ring binder mechanism according to claim 1, wherein each or said securing member has a first longitudinal end and a second longitudinal end, that said first longitudinal end is securable with an upper surface of said housing around said through hole, and that said second longitudinal end is adapted to be engaged and in contact with a first major surface of said substrate.

4. A ring binder mechanism according to claim 3, wherein when said ring binder mechanism is secured with said substrate, said side skirts are adapted to abut a second major surface of said substrate which is opposite to said first major surface along said at least part of the length of said side skirts.

5. A ring binder mechanism according to claim 1, wherein each or said through hole has a central aperture and a plurality of recesses adjoining said central aperture.

6. A ring binder mechanism according to claim 5, wherein each said recess has two edges which subtend an angle of substantially 50°.

7. A ring binder mechanism according to claim 1, wherein said side skirts are adapted to abut said substrate along at least a majority of the length of said side skirts.

8. A ring binder mechanism according to claim 1, wherein each of said side skirts includes at least one abutting structure adapted to abut said substrate.

9. A ring binder mechanism according to claim 8, wherein when said ring binder mechanism is secured with said substrate, said abutting structures are substantially perpendicular to a major surface of said substrate.

10. A ring binder mechanism according to claim 8, wherein each said abutting structure includes at least one protrusion.

11. A ring binder mechanism according to claim 8, wherein each said abutting structure includes at least one recess.

12. A ring binder mechanism according to claim 8, wherein at least one of said side skirts includes at least two abutting structures which are parallel to and aligned with each other.

13. A ring binder mechanism according to claim 8, wherein said abutting structures of said side skirts are parallel to each other.

14. A paper-retaining device including a ring binder mechanism according to claim 1 secured with a substrate, wherein said through hole is secured with said substrate via one securing member only, and that said side skirts abut said substrate along at least part of the length of said side skirts.
